(19) United States
(12) Patent Application Publication
(10) Pub. No.: US 2014/0058025 A1
(43) Pub. Date: Feb. 27, 2014

(54) FLAME RETARDANT, THERMOPLASTIC POLYCARBONATE MOLDING COMPOSITIONS

(71) Applicants: Alexander Meyer, Dusseldorf (DE); Berit Stange, Opladen (DE); James Y. J. Chung, Wexford, PA (US)

(72) Inventors: Alexander Meyer, Dusseldorf (DE); Berit Stange, Opladen (DE); James Y. J. Chung, Wexford, PA (US)

(73) Assignee: BAYER INTELLECTUAL PROPERTY GMBH, Monheim (DE)

(21) Appl. No.: 13/984,528

(22) PCT Filed: Feb. 9, 2012
(86) PCT No.: PCT/EP2012/052187

§ 371 Date: Oct. 22, 2013

Related U.S. Application Data
(60) Provisional application No. 61/441,766, filed on Feb. 11, 2011.

(51) Int. Cl. C08L 69/00

(52) U.S. Cl. CPC C08L 69/00
USPC 524/165

(57) ABSTRACT

A flame-retardant thermoplastic molding composition is disclosed. The composition contains aromatic polycarbonate resin, about 0.01 to 0.15 wt.-% of a salt, wherein the salt is an alkali metal or alkaline earth metal salt of perfluoroalkane sulfonic acid, aromatic sulfimide, ar aromatic sulfonic add, and about 0.5 to 10 wt.-% of poly- and/or oligo-aryloxysiloxane (herein after referred as aryloxysiloxane) as flame-retardant synergist. The inventive composition is characterized in that its flammability rating is better than that of aromatic polycarbonate resin containing only inorganic salt of a derivative from aliphatic or aromatic sulfonic acid, sulphonamide or sulfonimide in accordance with UL-94 V standard, while mechanical and optical properties of the compositions are maintained.

### BACKGROUND

1. Field of the Invention

The invention relates to thermoplastic molding compositions and in particular to flame retardant polycarbonate compositions.

2. Description of Related Art

Resins with flame retardant properties have a wide range of applications. Typical fields of such resins are the electronics and electrical markets, for example, housings for EE, TV and computer housings; another important application field is also the transportation sector. Here these resins are used e.g. for interior lining of trains and air planes. In addition to good flame retardant properties, these applications require that the optical, the mechanical, the impact and the thermal properties have to be maintained on a high level. This combination of properties is often not easy to obtain. By using typical flame retardant (FR) additives, the flame retardant properties of the resins can be adjusted to the desired level. However, if a high amount of FR additive is required, other properties such as optical or mechanical properties usually deteriorate.

Aromatic polycarbonates in general show satisfactorily flame retardant properties. However, they do not comply with the stringent requirements for UL rating of thin walled parts.

To overcome this deficiency, often fluorinated polymers are added to the composition. However, a major drawback of using fluorinated polymers, such as polytetrafluoroethylene (PTFE) is that optical and impact properties deteriorate significantly compared to flame retardant polycarbonates without fluorinated polymers.

Arylsiloxanes in general are well known and methods for the synthesis of polyaryloxysiloxanes are described in EP-A 0398049.

U.S. Pat. No. 5,334,672 describes compositions using polyarylsiloxanes and polyethers, polyesters and polyimides, while compositions with polycarbonates are not disclosed.

U.S. Pat. No. 6,727,302 discloses polycarbonate compositions containing silicone oils and salts leading to improved flame retardant properties in combination with good optical properties. However, since the silicone oil is liquid, its use has significant drawbacks in the industrial production of the compositions compared to a solid material.

JP 2007297447 discloses compositions containing arylalkylsilicones in combination with PTFE. These compositions are not applicable when good optical and mechanical properties in combination are needed.

JP 2003-049060 discloses polycarbonate compositions containing phenolphthalein based siloxanes as FR-additives in combination with alkaline salts. Phenolphthalein derived polymers have also been reported to have good FR-properties (example described by Lin, M. S.; Pearce, E. M. in Journal of Polymer Science, Polymer Chemistry Edition (1981), 19(9), 2151-60). However, the phenolphthalein based siloxanes are well known to degrade in a humid environment, forming strong colored species as described in Steffen, Klaus Dieter, Angewandte Makromolekulare Chemie (1972), 24 21-33. In contrast, the compositions described in the present invention are not based on phenolphthalein.

### SUMMARY

An objective of the present invention was to develop improved flame retardant polycarbonate compositions overcoming the aforementioned deficiencies.

It has been found in the present invention that this problem can be solved by adding specific silicones to polycarbonate compositions, wherein the silicones are effective flame retardant synergists in combination with flame retardant salts.

The combination of the silicones with the flame retardant salts resulted in polycarbonate compositions having good flame retardant properties while the required optical and impact properties are retained.

In accordance with the present invention flame-retardant thermoplastic molding composition is disclosed. The composition comprises aromatic polycarbonate resin, about 0.01 to 0.15 wt.-% of a salt, wherein the salt is an alkali metal or alkaline earth metal salt of perfluoroalkane sulfonic acid, aromatic sulfimide, ar aromatic sulfonic acid, and about 0.5 to 10 wt.-% of poly- and/or oligo-aryloxysiloxane (herein after referred as aryloxysiloxane) as flame-retardant synergist. The inventive composition is characterized in that its flammability rating is better than that of aromatic polycarbonate resin containing only inorganic salt of a derivative from aliphatic or aromatic sulfonic acid, sulphonamide or sulfonimide in accordance with UL-94 V standard, while mechanical and optical properties of the compositions are maintained.

### DETAILED DESCRIPTION OF A PREFERRED EMBODIMENT

In summary, compared to the compositions described in prior art, the polycarbonate compositions comprising siloxanes and flame retardant salts reported in the present invention combine the benefits of easy handling, low cost production good optical and mechanical properties as well as good flame retardant properties.

The inventive thermoplastic molding composition comprises
a) aromatic polycarbonate resin,
b) at least 0.01 wt.-% of a salt, wherein the salt is optionally an alkali metal or alkaline earth metal salt of
b1) perfluoroalkane sulfonic acid, aromatic sulfimide, or aromatic sulfonic acid, and/or
b2) aliphatic or aromatic sulfonic acid, sulphonamide or sulfonimide, and
c) at least 0.05% of aryloxysiloxane as flame-retardant synergist.

The inventive composition is characterized in that its flammability rating is better than that of aromatic polycarbonate resin containing only inorganic salt of a derivative from aliphatic or aromatic sulfonic acid, sulphonamide or sulfonimide in accordance with UL-94 V standard, while r Mechanical and optical properties of the compositions are maintained.

The amount of salt is preferably present in an amount from 0.01 wt.-% to 0.20 wt.-%, more preferred from 0.01 wt.-% to 0.15 wt-%, and most preferred from 0.05 to 0.08 wt.-%.

The aryloxysiloxane is preferable present from 0.05 wt.-% to 10 wt.-%, more preferred from 0.10 wt.-% to 5.00 wt.-%, even more preferred form 0.75 wt.-% to 4.00 wt.-%, and most preferred from 1.00 to 3.00 wt.-%.

The aryloxysiloxanes suitable in the context of the present invention are represented by the following substances of the formula (1):

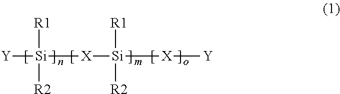

wherein
R1 and R2 stand independently for phenyl and substituted phenyl, preferably for phenyl. Further preferred R1 and R2 are identical.

In case of substituted phenyl groups for R1 and R2 the phenyl group may be substituted with hydrogen, C1 to C18-alkyl, C1 to C18-alkoxy, Cl, Br or with phenyl or benzyl, preferably substituted by hydrogen or C1 to C12 alkyl and more preferably with hydrogen or C1 to C8 alkyl like methyl or ethyl.

In case of substituted phenyl groups, 4-methyl-, 2-methyl, or 2,4-dimethyl phenyl groups are most preferred.

X denotes a bisphenolate moiety which may be substituted or is derived from cyclohexane dimethanol or tetramethylcyclobutandiol.

Preferably X denotes bisphenolate moieties derived from hydroquinone, 4,4′-dihydroxybiphenyl (DOD), bis-(4-hydroxyphenyl)-sulfide, bis-(4-hydroxyphenyl)-ether, 2,2-bis-(4-hydroxyphenyl)propan (Bisphenol A), 2,2-bis-(4-hydroxyphenyl)-1-phenylpropane, 1,1-bis-(4-hydroxyphenyl)-1-phenylethane, 2,4-bis-(4-hydroxyphenyl)-2-methylbutane, 1,3-bis-[2-(4-hydroxyphenyl)-2propyl]benzol, 2,2-Bis-(3-methyl-4-hydroxyphenyl)-propan, bis-(3,5-dimethyl-4-hydroxyphenyl)-methane, 2,2-bis-(3,5-dimethyl-4-hydroxyphenyl)-propane and most particular for 4,4′-dihydroxybiphenyl (DOD).

Y denotes hydrogen, C1 to C9-alkoxy-, phenyloxy, alkylphenyloxy, preferably hydrogen, C1 to C4-alkoxy, phenyloxy, vinyloxy, C1-C4-alkylphenyloxy, and more preferred methoxy-, ethyloxy-, propyloxy-, butyloxy-, isobutyloxy- or phenyloxy-. In a further embodiment the phenyloxy-moiety may be derived from substituted phenyloxy-compounds.

In an especially preferred embodiment Y denotes phenyloxy.

n is 0 or 1,
m denotes an integer, preferably from 1 to 55, more preferred from 2 to 30, and particular preferred from 3 to 20.
o is 0 or 1;
with the proviso that the molecular weight of the compound is within the limits given below.

The weight average molecular weight of formula (1) compound is 500-100000 g/mol analyzed by GPC (gel chromatography with bisphenol-A-standard). Preferred is a molecular weight (Mw, weight-average molecular weight) of 1000-20000, and particular preferred 2000-8000 determined by gel chromatography with bisphenol A standard. Thus, m, n and o in formula (1) denote an integer and determine the above mentioned molecular weight range.

Due to the polydispersity of the compound of formula (1), it is preferred that one terminus of the chains is terminated by endgroups Y derived from C1-C4-Alkoxy, Phenyloxy, Alkylphenyloxy and the other terminus is terminated by hydrogen.

Impurities of alkyl residues that may be present in the silicone raw materials can be incorporated into the polymer without negatively affecting the invention.

In another embodiment of the invention the compound of formula (1) can be branched. Suitable branching agents are e.g. phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methylphenol; 2,4-dihydroxybenzoic acid; 2-(4-hydroxyphenyl)-2-(2,4-dihydroxyphenyl)-propane and 1,4-bis-(4,4′-dihydroxytriphenylmethyl)-benzene. Furthermore suitable branching agents are tri- or tetrachlorosilane.

The manufacturing of compounds of formula (1) is known to a person skilled in the art. The compounds of formula (1) can be obtained by the reaction of dichlorosilanes with bisphenols using amines like triethylamine as acid scavengers. This reaction is described by Liaw et al. J. Polym. Sci, Part A Polym Chem. 1999, Vol. 37, 4591-4595. Furthermore, dianilinodiphenylsilanes can be reacted with aromatic dioles. This reaction is described by Saegusa et al. Polym Sci Part A: Polym Chem 1992, 30, 1402 and by Curry et al. J. Appl. Polym. Sci. 1965, 9, 295.

To obtain sufficient end cap levels small amounts of aliphatic mono alcohols or aromatic mono-hydroxy compounds are added during the reaction. Preferably phenols or alkyl-substituted phenols, or aliphatic alcohols like isopropanol, propanol, ethanol or methanol are used. These compounds are used in an amount of 0.1 mol. % to 30.0 mol. %, preferably in an amount of 0.5 mol. %-30.0 mol-% related to quantity of used dichlorsilane.

These components can be added in the beginning, within or at the end of the reaction. In a further embodiment of the invention the polysiloxane will be precipitated by using the above mentioned mono-hydroxy compounds. By this method also compounds of formula (1) can be obtained.

Suitable polycarbonate resins for preparing the compositions of the present invention are homopolycarbonates and copolycarbonates and mixtures thereof.

The polycarbonates generally have a weight average molecular weight of 10,000 to 200,000, preferably 20,000 to 80,000 (determined by GPC [gel permeation chromatography] with polycarbonate standard) and their melt flow rate, per ASTM D-1238 at 300° C., 1.2 kg, is about 1 to about 65 g/10 min., preferably about 2 to 15 g/10 min. They may be prepared, for example, by the known diphasic interface process from a carbonic acid derivative such as phosgene and dihydroxy compounds by polycondensation or by transesterification (H. Schnell, “Chemistry and Physics of Polycarbonates”, Interscience Publishers, New York, N.Y., 1964, incorporated herein by reference).

In the present invention, dihydroxy compounds suitable for the preparation of the polycarbonates of the invention conform to the structural formulae (1) or (2).

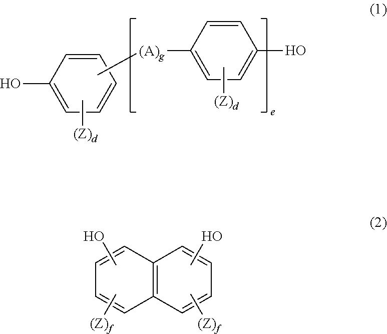

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

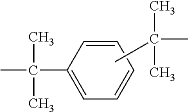

e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,105,004; 5,126,428; 5,109,076; 5,104,723; 5,086,157; 3,028,356; 2,999,835; 3,148,172; 2,991,273; 3,271,367; and 2,999,846, all incorporated herein by reference.

Further examples of suitable bisphenols are 2,2-bis-(4-hydroxy-phenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are phenolphthalein-based polycarbonate, copolycarbonates and terpoly-carbonates such as are described in U.S. Pat. Nos. 3,036,036 and 4,210,741, both incorporated by reference herein.

The polycarbonates of the invention may also be branched by condensing therein small quantities, preferably 0.05 to 2.0 mol % (relative to the bisphenols) of polyhydroxyl compounds.

Polycarbonates of this type have been described, for example, in U.S. Pat. Nos. 3,544,514. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference, U.S. Pat. Nos. 3,028,365; 2,999,846; 3,153,008; and 2,991,273.

The preferred processes for the preparation of polycarbonates are the interfacial or melt polycondensation process.

Other methods of synthesis in forming the polycarbonates of the invention, such as disclosed in U.S. Pat. No. 3,912,688, incorporated herein by reference, may be used.

A polycarbonate resin suitable in the practice of the invention is known and its structure and methods of preparation have been disclosed, for example, in U.S. Pat. Nos. 3,030,331; 3,169,121; 3,395,119; 3,729,447; 4,255,556; 4,260,731; 4,369,303 and 4,714,746 all of which are incorporated by reference herein.

The preferred polycarbonate resin in the present context contains in its molecular structure neither halogen nor units derived from thiodiphenol.

The inventive composition may further contain one or more conventional functional additives such as antistatic agents, antioxidants, lubricants, mold release agents, colorants, optical brighteners and UV stabilizers.

Suitable UV absorbers include hydroxybenzophenones, hydroxybenzotriazoles, hydroxybenzotriazines, cyanoacrylates, oxanilides, and benzoxazinones.

Suitable stabilizers include carbodiimides, such as bis-(2,6-diisopropylphenyl) carbodiimide and polycarbodiimides; hindered amine light stabilizers; hindered phenols (such as Irganox 1076 (CAS number 2082-79-3), Irganox 1010 (CAS number 6683-19-8); phosphites (such as Irgafos 168, CAS number 31570-04-4; Sandostab P-EPQ. CAS number 119345-01-6; Ultranox 626, CAS number 26741-53-7; Ultranox 641, CAS number 161717-32-4; Doverphos S-9228, CAS number 154862-43-8), triphenyl phosphine, and phosphorous acid.

Suitable hydrolytic stabilizers include epoxides such as Joncryl ADR-4368-F, Joncryl ADR-4368-S, Joncryl ADR-4368-L, cycloaliphatic epoxy resin ERL-4221 (CAS number 2386-87-0).

Such stabilizer additives are known in the art and are disclosed in standard reference works such as “Plastics Additives Handbook”, 5th edition, edited by H. Zweifel, Hanser Publishers incorporated herein by reference.

The additives may be used in effective amounts, preferably of from 0.01 to a total of about 30.00% relative to the total weight of the polycarbonate composition. The inventive molding composition is suitable for articles by any of the thermoplastic processes, including injection molding and extrusion.

Suitable flame retardant salts according to the present invention are alkaline metal and alekaline earth metal salts of aliphatic or aromatic sulfonic acid, aliphatic or aromatic sulphonamide or aliphatic or aromatic sulfonimide.

Preferably the flame retardant salts are selected from the group comprising sodium perfluorobutane sulfonate, potassium perfluorobutane sulfonate, sodium perfluoromethylbutane sulfonate, potassium perfluoromethylbutanesulfonate, sodium perfluoromethane sulfonate, potassium perfluoromethane sulfonate, sodium perfluoroethane sulfonate, potassium perfluoroethane sulfonate, sodium perfluoropropane sulfonate, potassium perfluoropropane sulfonate, sodium perfluorohexane sulfonate, potassium perfluorohexane sulfonate, sodium perfluoroheptane sultanate, potassium perfluoroheptane sulfonate, sodium perfluorooctane sulfonate, potassium perfluorooctane sulfonate, tetraethylammonium perfluorobutanesulfonate and tetraethylammoniumperfluorabutanesulfonate, potassium-diphenyl-sulfone-sulfonate, sodium 2,5-dichlorobenzenesulfonate, potassium 2,5-dichlorobenzenesulfonate, sodium 2,4,5-trichlorobenzenesulfonate, potassium 2,4,5-trichlorobenzenesulfonate, sodium diphenylsulfone-sulfonate, potassium diphenylsulfone-sulfonate, sodium 2-formylbenzenesulfonate, potassium 2-formylbenzenesulfonate, sodium (N-benzenesulfonyl)-benzenesulfonamide, potassium sodium (N-benzenesulfonyl)-benzenesulfonamide, N-(p-tolylsulfonyl-)-p-toluenesulfimide-potassium salt, N—(N′-Benzylaminocarbonyl)-sulfanylimide potassium salt, and mixtures thereof.

Particular preferred are sodium perfluorobutane sulfonate, potassium perfluorobutane sulfonate, sodium perfluorooctane sulfonate, potassium perfluorooctane sulfonate, sodium diphenylsulfone-sulfonate, potassium diphenylsulfone-sulfonate, and N-(p-tolylsulfonyl-)-p-toluenesulfimide-potassium salt.

Most preferred is potassium nona-fluor-1-butane sulfonate.

### Experimental

Compositions in accordance with the invention were prepared and their properties evaluated as described below. The indicated components noted in the table, amounts noted in percent by weight, were processed conventionally and the test specimens were molded following conventional procedures and practices. The makeup of the exemplified compositions and their properties are shown in the tables below.

### Optical Measurements:

Determinations of haziness and transmission were carried out according to ISO 13468. The yellowness index Yl was measured according to ASTM E313.

### UL Test Procedure Rating Criteria

The flame resistance of plastics is determined by the UL94V method (in this respect, see

### a) “Test for Flammability of Plastic Materials for Parts in Devices and Appliances”, S14 ff, Northbrook 1998;

b) J. Troitzsch, “International Plastics Flammability Handbook”, S. 346 ff., Hanser Verlag, München 1990),
which is extensively used in the electrical/electronics field. Using this method the afterburning times and drip off behavior of ASTM standard test specimens are determined. For a flame proofed plastic material to be classified in fire classification UL94 V-0, the following criteria must be fulfilled: for a set of 5 standard ASTM test specimens (dimentions: 127×12.7×X, with X=thickness of the test bar, e.g. 3.0; 2.8; 2.6; 2.4 mm) all the specimens must exhibit an after burn time witch is no longer than 10 seconds after two times of flame application of 10 seconds of an open flame of defined height. The sum of the after burn times for 10 ignitions of 5 specimens must not be greater than 50 seconds. Moreover, the test specimen concerned must not exhibit burning drip off behavior, complete combustion or after glow for longer than 30 seconds. Classification UL94V1 requires that the individual after burning times are no longer than 30 seconds and that the sum of the afterburning time after 10 ignitions of 5 specimens is no greater than 250 seconds. The total after glow time must not be longer than 250 seconds. The remaining criteria are identical mentioned to above. A material is given a fire classification of UL94 V-2 if it exhibits burning drip off behavior but fulfills all other criteria of UL94 V-1

### Rheological Properties:

Determination of MVR was carried out pursuant ASTM D1238 MVR (300° C./1.2 kg).

### Preparation of Polydiphenylsiloxane Based on Dihydroxyl Biphenyl Containing Methoxy-Terminal Groups.

931 g (5.0 mol) 4.4″-dihydroxybiphenyl is submitted in a boiler under nitrogen in 10 liters of absolute toluol. 1113 g (10.8 mol) of freshly distilled triethylamine dissolved in 5 liters toluol is added to this solution. The solution is heated up to 80° C. and stirred at this temperature. 1344 g (5.2 mol) diphenyldichlorsilane is dripped into the reaction mixture slowly (approximately 1 hour). The reaction mixture is stirred for approximately 12 hours at this temperature. It is then left to cool and the hydrochloride is separated by means of a suction filter. The filtrate is put into approximately 100 liters of methanol and the product precipitated. The raw product is filtered off, dried and dissolved in a mixture of dichlormethane and tetrahydrofurane (6:1). This mixture is precipitated in methanol. The precipitated product is suctioned off, rewashed with methanol and dried at 40° C. in a vacuum drying cabinet. 977 g of a white solid is obtained.

The molecular weight of the product is equal to Mw=3,600 g/mol (GPC, using bisphenol A as standard)

In ¹H-NMR the singlet indicates the presence of methoxy-terminal groups at 3.65 ppm.

Compositions in accordance with the invention were prepared and their properties evaluated. The makeup of the exemplified compositions and their properties are shown in the tables below.

In the preparation of the compositions the following components were used:

Polycarbonate (referred to below as PC): Makrolon 2608, a bisphenol-A based homopolycarbonate, a product of Bayer Polymers, having a melt flow rate of 10 g/10 min. as determined at 300° C./1.2 kg load in accordance with ASTM D1238.

Polycarbonate powder (referred to below as PCP): Makrolon 3108, a bisphenol-A based homopolycarbonate, a product of Bayer Polymers, having a melt flow rate of 6 g/10 min, as determined at 300° C./1.2 kg load in accordance with ASTM D1238.

Aryloxysiloxane (referred to below in Table 1 as A) was introduced to the compositions in the form of powder.

C4 (Potassium-nona-fluor-1-butanesulfonate) is a product of Lanxess available under the trade name Bayowet® C4.

The compositions were prepared by conventional means and routine procedures that are well known in the art.

The compositions in the examples and comparative examples 1 to 3 are produced by adding 10 wt. % of a powder mixture consisting of Makrolon® 3108 (PCP) powder containing the salt and component A as specified in the examples to 90 wt. % of Makrolon® pellets (PC) to produce the compositions specified in the examples, wherein the amounts in wt.-% add up to 100% and relate to the weight of the total composition. The compositions according to the present invention are compounded in a device comprising a metering unit for the components, a co-rotating twin-screw compounder (ZSK 25 from Werner & Pfleiderer) having a screw diameter of 25 mm, a perforated nozzle for extruding the melt strands, a water bath for cooling and solidifying the strands, and a pelletiser.

TABLE 1

| | 1 (control) | 2 | 3 |
|---|---|---|---|
| PC, wt.-% | 90.00 | 90.00 | 90.00 |
| PCP, wt.-% | 9.94 | 8.94 | 6.94 |
| C4, wt.-% | 0.06 | 0.06 | 0.06 |
| A, wt.-% | 0.00 | 1.00 | 3.00 |
| Impact Strength, Izod | 81 | 83 | 82 |
| notched, ISO180/4a, 23° C. | | | |
| ΔTransmission | 0 | 0 | 1.6 |
| ΔHaze | 0 | 0 | 0 |
| ΔYellowness Index | 0 | 0.3 | 2.5 |
| Flame Retardance | | | |
| UL94-V @ 3.0 mm | V0 | V0 | V0 |
| UL94-V @ 2.8 mm | V2 | V1 | V0 |
| UL94-V @ 2.6 mm | V2 | V1 | V0 |
| UL94-V @ 2.4 mm | V2 | V2 | V1 |

The results shown in Table 1 demonstrate the improved flame retardancy characterizing the inventive compositions. The Δ values were calculated relative to the values of comparative example 1 (without arylsiloxane). Namely, the data generated show that compared to the compositions described in prior art without an arylsiloxane, the polycarbonate compositions comprising siloxanes and flame retardant salts reported in the present invention combine the benefits of easy handling, low cost production, good optical (transmission is 1.6 as compared to a control of 0; yellowness is 0.3 or 2.5 compared with 0 for control; and haze remains unchanged despite addition of arylsiloxane) and mechanical properties (notched, ISO180/4a at 23C is at least 1% increased over control), as well as good flame retardant properties (flame retardance measurement of V1 or V0 at UL 94-V @ 2.8 mm or UL94V @ 2.6 mm).

1. A thermoplastic molding composition comprising:
a) an aromatic polycarbonate resin,
b) from 0.01 to 0.8 wt.-% of an inorganic salt of a derivative from an aliphatic or aromatic sulfonic acid, sulphonamide or sulfonimide,
c) from 0.05 to 10 wt.-% of a poly- and/or oligo-aryloxysiloxane of formula (1), 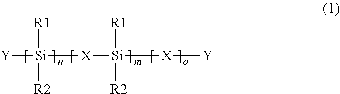
wherein
R1 and R2 stand independently for phenyl and/or substituted phenyl,
X denotes a bisphenolate moiety,
Y denotes hydrogen, C1-C9-alkoxy-, phenyloxy-, vinyloxy- and alkylphenyloxy,
n is 0 or 1,
m denotes an integer,
o is for 0 or 1,
and the weight average molecular weight of said aryloxysiloxane of formula (1) is from 500 to 100.000,
and wherein all % are relative to the weight of the composition.

2. A composition of claim 1, wherein R1 and R2 of formula (1) are phenyl.

3. A composition of claim 1, wherein the X in formula (1) denotes dioxybiphenyl.

4. A composition of claim 1, wherein X denotes a 4,4′-dioxydiphenyl moiety and Y denotes phenyloxy and n=1 and o=1 and m is from 1 to 55.

5. A composition of claim 4, wherein in formula (1), a first Y denotes phenyloxy and another Y denotes hydrogen.

6. A composition of claim 1, wherein said poly- and/or oligo-aryloxysiloxane of formula (1) is present in an amount of from 0.10 to 5.00 wt.-%.

7. A composition of claim 1, wherein said poly- and/or oligo-aryloxysiloxane of formula (1) is present in an amount of from 1.00 to 3.00 wt.-%.

8. A composition of claim 1, wherein said salt (b) is present in an amount of from 0.01 to 0.15 wt.-%.

9. A composition of claim 1, wherein said salt (b) is present in an amount of from 0.05 to 0.10 wt.-%.

10. A composition of claim 1, wherein said weight average molecular weight of component c) is from 1000 to 20.000.

11. A composition of claim 1, wherein said poly- and/or oligo-aryloxysiloxane of formula (1) comprises at least one end group selected from the group consisting of phenyloxy, alkylphenyloxy, methyloxy, ethyloxy and propyloxy radicals.

12. A composition of claim 1, wherein said salt (b) is at least one member selected from the group consisting of sodium perfluorobutane sulfonate, potassium perfluorobutane sulfonate, sodium perfluoromethylbutane sulfonate, potassium perfluoromethylbutanesulfonate, sodium perfluoromethane sulfonate, potassium perfluoromethane sulfonate, sodium perfluoroethane sulfonate, potassium perfluoroethane sulfonate, sodium perfluoropropane sulfonate, potassium perfluoropropane sulfonate, sodium perfluorohexane sulfonate, potassium perfluorohexane sulfonate, sodium perfluoroheptane sulfonate, potassium perfluoroheptane sulfonate, tetraethylammonium perfluorobutanesulfonate and tetraethylammoniumperfluorobutanesulfonate and potassium-diphenyl-sulfone-sulfonate.

13. A composition of claim 1, wherein said salt (b) is potassium nona-fluor-1-butane sulfonate.

14. An article of manufacture comprising said composition of claim 1.

15. A composition comprising:
a) aromatic polycarbonate resin,
b) at least 0.01 wt.-% of a salt, wherein the salt is optionally an alkali metal or alkaline earth metal salt of:
b1) perfluoroalkane sulfonic acid, aromatic sulfimide, or aromatic sulfonic acid, and/or;
b2) aliphatic or aromatic sulfonic acid, sulphonamide or sulfonimide, and
c) at least 0.05% of aryloxysiloxane as flame-retardant synergist.

16. A composition of claim 15, wherein the flammability rating thereof in accordance with UL-94 V standard is improved from that of said composition when said component (c) is not included, while mechanical and optical properties of the composition with and without said component (c) are maintained.
